(19) United States
(12) Patent Application Publication
(10) Pub. No.: US 2012/0072357 A1
(43) Pub. Date: Mar. 22, 2012

(54) Method and system for predicting property values within discrete finite market elements

(75) Inventors: Jeffery Joseph Bradford, San Jose, CA (US); Mark Randall Linne, Bailey, CO (US)

(73) Assignee: BRADFORD TECHNOLOGIES, INC., San Jose, CA (US)

(21) Appl. No.: 12/888,397

(22) Filed: Sep. 22, 2010

(51) Int. Cl. G06Q 50/00

(52) U.S. Cl. 705/306

(57) ABSTRACT

Methods, systems and computer-readable medium for enabling improved market value and sales price calculations are provided. In one case, a plurality of data sets are analyzed by a computer to derive a predictive equation. Each data set contains (a.) a sales price of a particular real property; and (b.) a plurality of quantitative parameters of qualities and conditions related to or descriptive of that particular real property. A human analyst then reviews the predictive equation and may modify the equation in light of the analyst's personal knowledge or research of a geographic area or neighborhood comprising the real properties of the data sets. The modified equation may only be applied to a geographic area associated with the human analyst. The invented method may be applied to forecasting and valuations in general, wherein a general valuation equation is computationally generated and an analyst modifies the equation.

### FIELD OF THE INVENTION

The present invention relates generally to predictive modeling methods and systems, and more particularly to predictive modeling of dynamics within discrete domains where the methods are crafted, evaluated and modified by a human expert of computationally derived predictive models and with local knowledge of dynamics within the domain.

### BACKGROUND OF THE INVENTION

Applications of predictive modeling have grown in step with the development and deployment of information technology. Computationally derived models have been applied in numerous industries and areas to forecast demand, growth, pricing, valuations, and/or risk. These areas and industries include, but are not limited to, the financial services industry, especially in the securitization of various debt instruments and commodities price forecasting; the electrical power industry in evaluating infrastructure integrity, future demand and equipment deployment and management; population growth modeling; natural resources depletion forecasting; econometrics; and in the valuation forecasting of real property, capital equipment and durable goods.

There is currently a plethora of commercially available, open source and freeware software that executes an automated analysis of sets of resultant values and parameters to generate a valuation equation that “best” fits the input data. These computationally generated valuation equations may be applied in an effort to predict resultant value forecasts given a full set of relevant parameters. These software products include an Autobox™ software product, or an automatic box-Jenkins modeling software program that applies autoregressive integrated moving average modeling and transfer function modeling; an EViews™ software product, or Econometric Views™; a GAUSS™ software product; Gretl™, or Gnu Regression, Econometrics and Time-series Library™ software; OxMetrics™ software program, or Ox based econometrics software that applies the Ox software language; a RATS™ software product, or regression analysis of time series software; a Speakeasy/Modeleasy™ software product; the Stata™ modeling software package; the SPPS™ Statistical Package for the Social Sciences software product; and the MiniTab™ Software product.

The prior art includes many methods of generating predictive equations that model complex systems and generate predicted values as derived from a collection of data sets, wherein each data set contains associated measured parameters related to a same complex system. These prior art system modeling and value predictive methods include, but are not limited to, regression analysis; Bayesian linear regression; least absolute deviations; quantile regression; finite element analysis and modeling; nonparametric regression; distance metric learning; and the Monte Carlo simulation method.

In prior art computational modeling, regression analysis is often applied to generate a predictive valuation equation derived from accepting a plurality of sets of data, wherein each data set includes a quantitative parameter for each of a plurality of defined qualities relevant to valuing elements of a domain of interest. For example, and considering a computer modeling system that is designed to generate equations used to calculate valuations of real property that indicate market values of specific real properties, each parameter of a relevant data set would be a quantitative value of some quality of or related to an individual and distinguishable real property that is located within a specified geographic domain. Each quality could be a characteristic of the real property associated with an individual data set, or of the domain of geography within which the real property is contained.

Regression analysis includes techniques for modeling and analyzing several variables, when the focus is on the relationship between a resultant dependent variable and a plurality of independent variables. More specifically, regression analysis attempts to predict how a dependent value changes as the independent variables vary. Most commonly, regression analysis estimates the conditional expectation of the dependent variable given the independent variables—that is, the average value of the dependent variable when the independent variable parameters are held fixed. In all cases, the estimation target is a function of the independent variables called the regression function, which is a form of a valuation equation. In regression analysis, it is also sometimes of interest to characterize the variation of the dependent variable around the regression function, which can be described by a probability distribution.

Regression analysis is widely used to generate equations for use in prediction and forecasting, where its use has substantial overlap with the field of computer-generated modeling. Regression analysis is also used to understand which among a plurality of independent variables are related to a dependent variable, and to explore the forms of these relationships. In restricted circumstances, and sometimes generating false findings, regression analysis is relied upon to infer causal relationships between one or more parameters and a value of interest.

A large body of techniques for carrying out regression analysis has been developed. Familiar methods such as linear regression and ordinary least squares regression are parametric, in that the regression function is defined in terms of a finite number of unknown parameters that are estimated from a plurality of data sets.

The performance of regression analysis methods in practice depends on the design and actual application of the data-generating method, and how the data generating method relates to the regression approach being used. Since the true form of the data-generating process is not known, regression analysis depends to some extent on making assumptions about this process. These assumptions are sometimes (but not always) testable if a large amount of data is available. Regression models for prediction are often useful even when the assumptions are moderately violated, although they may not perform optimally. However, in many applications, especially with small effects or questions of causality based on observational data, regression methods can give misleading results.

The application of computationally derived predictive models has more than once shown their downside and shaken public and professional confidence in blind applications of such tools. The international financial crisis of 2009 particularly scarred the psyche of many government and business leaders as well as the general public. The inclusion of human oversight in predictive modeling, to include the modeling of current and future market values of financial securities, mortgages and real property, has gained favor as a consequence of increased skepticism of purely computationally based approaches of valuation generation.

It is clear to many observers that human expertise should be applied to evaluating models that will be relied upon for guidance in making important decisions and/or in selecting investment opportunities. The very complexity of a situation that makes computational modeling attractive often suggests to decision makers that computationally derived models are more likely to fail to take into account important factors, subtleties and nuances of complex environments that human expertise might be quick to identify and evaluate from the perspective of potential impact on the valuation of a given property or properties.

Human expertise can often, for example, spot the likelihood of a seldom occurring asynchronous event that lies outside the parameters of a computer generated model, even in the case of a mathematical model that is continuously or routinely updated by an automated computational modeling system. Human expertise can also more quickly detect the significance of certain new conditions and accordingly, respond and apply more quickly, an understanding of one or more such conditions to valuation and forecasting model faster than a computational modeling system could integrate new parameters to change a value forecasting equation, such as a market value generation equation. Human expertise may also be applied to modify a general predictive equation in light of a pending change of condition that will affect a domain, where the pending change has not yet occurred and no new data that would indicate an affect of the pending change is available for input to a computational modeling system. Furthermore, a local expert might at times better understand the significance of a feature or aspect of a domain that is not reflected in the sets of parameters used to generate a valuation equation, in which case the affect of a change of condition of the domain might be better understood by the local expert due to a superior depth of knowledge of the relatedness of local features, conditions, potentialities of change, public perceptions and/or attitudes, and aspects to a change of condition.

There is, therefore, a long felt need to continue to benefit from the computational generation of computational models and forecasting equations, such as domain-specific market price valuation equations, while integrating human expertise in improving the reliability, accuracy and effectiveness in the application of such models and equations.

### OBJECTS OF THE INVENTION

It is an object of the method of the present invention to improve the quality of the application of computer-generated predictive equations, that include, but are not limited to, market value and/or sale price predictive equations;

It is an additional optional object of the method of the present invention to provide a graphical user interface that enables a user to define or delineate a domain by visualized selection from a computer-generated or computer-rendered image;

It is a yet additional optional object of the method of the present invention to provide a graphical user interface that enables a user to define or delineate an area of a geographic map by visualized selection from a computer-generated or computer-rendered map image;

It is another additional optional object of the method of the present invention to provide access to computational modeling and human expertise in valuation, such as value forecasting, by means of an information technology system; and

It is another additional optional object of the method of the present invention to provide access to computational modeling and human expertise in valuation, such as value forecasting, by means of an electronics communications network, such as the Internet and/or a cellular telephone network.

### SUMMARY OF THE INVENTION

This and other objects of the present invention are made obvious in light of this disclosure, wherein methods, systems and computer-readable media for predicting values, such as market value and sales price, are provided.

According to a first aspect of the method of the present invention, a method and system are provided to generate a valuation equation that is used to calculate a predicted sales, rental, or lease price of a property, to include, but not limited to, a real property, a capital equipment, and an intellectual property or an intellectual property right.

According to a second aspect of the method of the present invention, a human analyst modifies the computationally generated valuation equation, and the modified valuation equation is applied to calculate predicted sales prices. This equation modification process by the human analysts may be iterative, in that multiple modifications of the valuation equation may occur until such time as the human analyst determines that the final form of the equation is appropriate, based upon the analyst's knowledge, experience, intuition and judgment.

According to a third and optional aspect of the method of the present invention, a graphical user interface is provided by means of an information technology system that enables a user to select access to an analyst-modified valuation equation, such as a predicted sales price generating equation.

According to a fourth and optional aspect of the method of the present invention, a graphical user interface is provided by means of an information technology network, such as the Internet, that enables a user to select access to an analyst-modified valuation equation generated by an analyst.

According to a fifth and optional aspect of the method of the present invention, an application of at least one modified real estate market valuation equation includes calculating predicted sales prices of real property located within a geography associated with a human analyst that modified the modified real estate market valuation equation.

According to a sixth and optional aspect of the method of the present invention, a graphical user interface is provided that enables a user to define or delineate a domain by visualized selection from a computer-generated or computer-rendered image, for example, enabling a user to define a domain that comprises an area of geography that contains real properties.

According to a seventh and optional aspect of the method of the present invention, a valuation equation is provided to a user to allow the user to modify coefficients and the characteristics of the value equation, and to further allow the user to enter individual parameters and sets of parameters for calculation of a predicted value, such as a sales price of a real property and/or collate a portfolio of properties in association with predicted sales prices and/or valuations.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations further include U.S. Pat. No. 5,361,201 (Inventors: Jost, et al.; issued on Nov. 1, 1994) titled “Real estate appraisal using predictive modeling”; U.S. Pat. No. 7,711,574 (Inventors: Bradley, et al.; issued on May 4, 2010) titled “System and method for providing automated value estimates of properties as of a specified previous time period”; and U.S. Pat. No. 7,788,186 (Inventors: Ann, et al.; issued on Aug. 31, 2010) titled “Method and system for automated property valuation adjustment”.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 illustrates a computer generated geographic map that shows a bounded area polygon positioned within a larger geography;

FIG. 2 is an illustration of a data set software record that includes a plurality of parameters and a dependent value;

FIG. 3 is an illustration of a real property data set record that includes a plurality of parameters related to a same real property and a market valuation and/or sales price;

FIG. 4 is illustration of an appraiser's personal data record;

FIG. 5 is a flow chart of a computer-implemented process wherein a market value and/or sale price equation is derived;

FIG. 6 is an illustration of a valuation equation data record;

FIG. 7 is an illustration of a computer-assisted process wherein a human analyst modifies a previously generated market price value equation;

FIG. 8A is a flow chart of certain alternate aspects of step 7.10 of the process of FIG. 7, wherein coefficients and operation information are modified or deleted;

FIG. 8B is a flow chart of certain still alternate aspects of step 7.10 of the process of FIG. 7, wherein coefficients and operation information are modified or deleted;

FIG. 9 is a flow chart of still alternate aspects of step 7.10 of the process of FIG. 7, wherein coefficients and operation information are added to an analyst modified valuation equation;

FIG. 10 is an illustration of an analyst-generated valuation equation data record wherein an analyst-modified valuation equation is stored;

FIG. 11 is an illustration of a computer display presenting a graphical user interface whereby a user may select a property and may selectively direct a hosting computer to apply one or more market value and/or sales price predicting equations;

FIG. 12 is a flowchart of a process wherein another party, such as a person or an automated system, accesses an automatically generated valuation equation and/or an analyst modified valuation equation;

FIG. 13 is a schematic of an electronics communications network comprising the Internet, a client system, an analyst system, and a database server; and

FIG. 14 is a schematic of a computer that may serve as the client system, the analyst system, and/or the database system of FIG. 13; and

FIG. 15 is a flowchart of a method implemented by the client system of FIGS. 13 and 14 in interaction with the user to generate varied valuations of one or more real properties of FIG. 1.

### DETAILED DESCRIPTION

It is to be understood that this invention is not limited to particular aspects of the present invention described, and as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

The upper and lower limits of these smaller ranges may independently be included in the smaller ranges and are also encompassed within the invention, subject to any specifically excluded limit in the stated range. Where the stated range includes one or both of the limit ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Prior art computer-implemented modeling systems include systems that accept data sets and then automatically generate an equation that is shaped to approximate an equation that would best satisfy each data set, wherein each data set includes a single resultant value and an associated plurality of parametric values. In an example of electrical power generation, the resultant value might be the amount of energy recorded as being consumed at a certain time period within a defined power grid. The parameters would be quantitative factors relating to the power grid of interest, its surroundings and environment, such as air temperature experienced during the time period of interest, population, counts of domiciles and industrial properties, measures of automotive traffic and other measurable or estimated quantitative values.

Certain prior art value equation modeling systems are programmed to produce pairs of coefficients a₀ through aₙ and parameters x₀ through xₙ that are solely additive in operation of the equation, and such equations would follow this model:

VALUE=a₀+a₁x₁+a₂x₂+a₃x₃+ . . . +aₙxₙ;

Wherein a₀ through aₙ are coefficients derived by the modeling system in an analysis of a plurality of data sets; and x₁ through xₙ parameters uniquely provided in each data sets.

It is understood that where each data set has n parameters, many prior art computer modeling systems work best when at least n complete data sets are provided for use in deriving a valuation equation.

Certain other prior art value equation modeling systems are enabled to produce valuation equations that includes functions other than the addition of multiplied pairs of coefficients a and parameters x. For example, an alternate value equation might include the following representative mathematical operations:

VALUE=a₀+(a₁x₁)²+a₂/x₂−x₃/a₃+(a₄x₄)^{1/2}+a₅(x₁)³ . . . +aₙxₙ.

The mathematical complexity of the computer generated valuation equation is typically limited only by the nature of the computational system selected for computer modeling and any design constraints imposed by the software architect of the applied modeling software.

It is understood that according to the method of the present invention, the computer generated valuation equation may be generated by application of one or more algorithms or modeling techniques in singularity or in combination. More specifically, the computer generated valuation equation may be generated by application of one or more of the algorithm, modeling and predictive value generation techniques of regression analysis; Bayesian linear regression; least absolute deviations; quantile regression; finite element analysis and modeling; nonparametric regression; distance metric learning; the Monte Carlo simulation method; neural networks; and other suitable techniques and algorithms known in the art.

In the method of the present invention, a human analyst (or “analyst”) may alter one or more of the coefficients a₀ through aₙ and/or change the function applied between one or more coefficients a₀ through aₙ and one or more parameters x₁ through xₙ, and/or one or more operations that may be imposed between or among one or more coefficients a₀ through aₙ and parameters x₁ through xₙ within the valuation equation. The analyst may also alter other elements of the process, including, but not limited to, increasing or decreasing the number of data points; altering the number of coefficients and parameter pairs utilized in the analysis; and changing the boundaries of the geospatially defined market area.

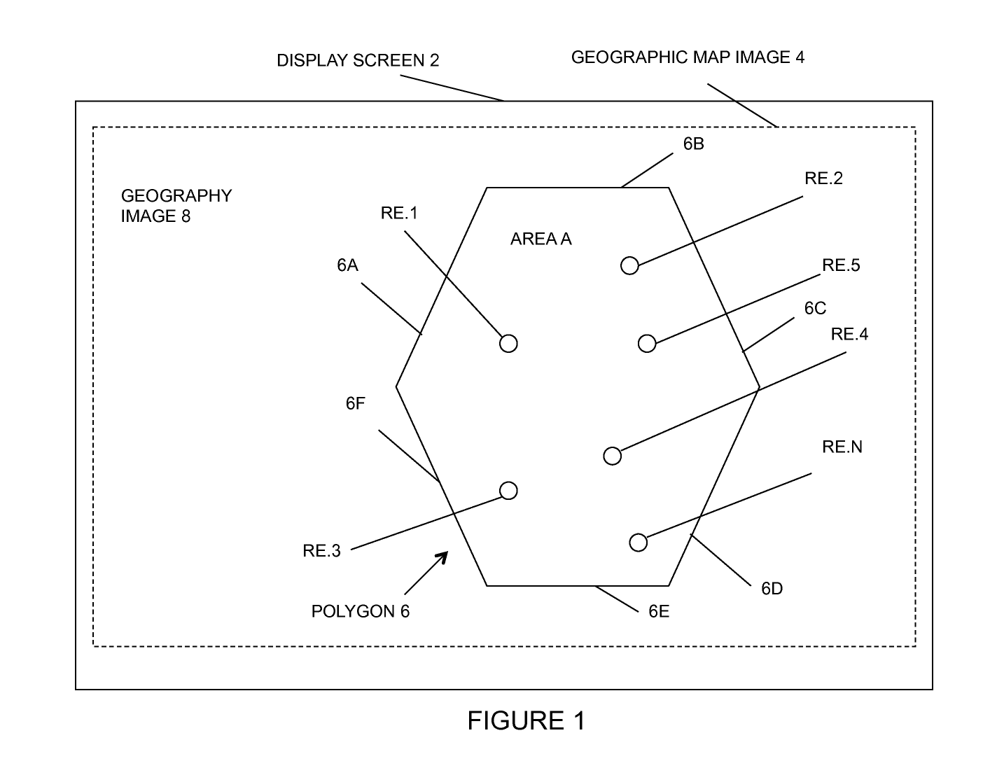

Referring now generally to the Figures and particularly to FIG. 1, FIG. 1 illustrates a video display screen 2 displaying a geographic map image 4 that presents a bounded area polygon 6 positioned within a larger geography image 8. The area A within the borders 6A-6F of the polygon 6 includes a plurality of real estate properties RE.1-RE.N. The bounded area A of real estate defined within the borders 6A-6F of the polygon 6 defines a unique, distinguishable and discrete finite market element.

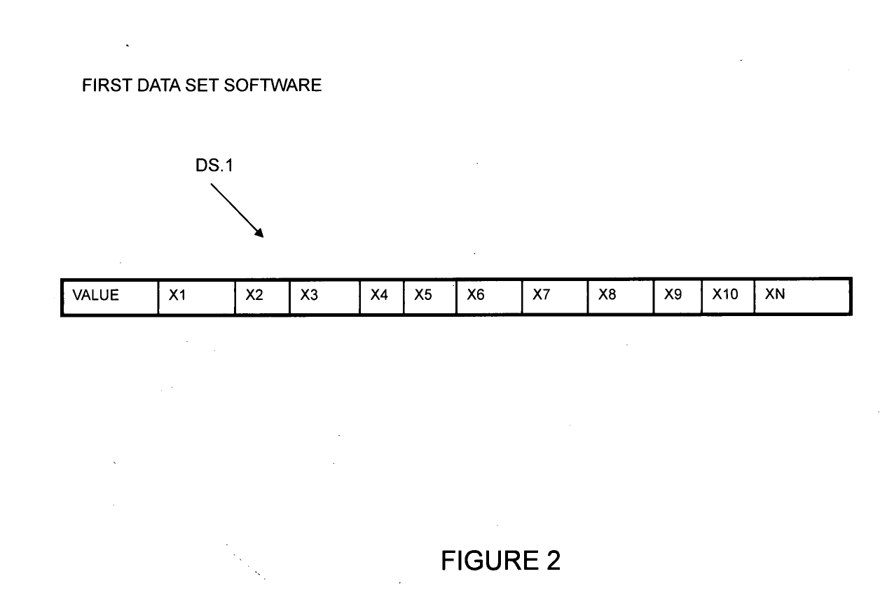

Referring now particularly to FIG. 1 and FIG. 2, the plurality of uniquely identifiable real properties RE.1-RE.N contained within the bounded area A each have a single, individually associated and unique data set DS.1-DS.N, wherein each data set DS.1-DS.N is associable with an identified real property and includes (a.) an actual sales price value of the identified real property, and (b.) a set of quantitative values that each describe an aspect of the same identified real property. In certain variations of the invented method, the sales price value of one or more data sets DS.1-DS.N may alternatively be an appraised value rather than an actual sales price.

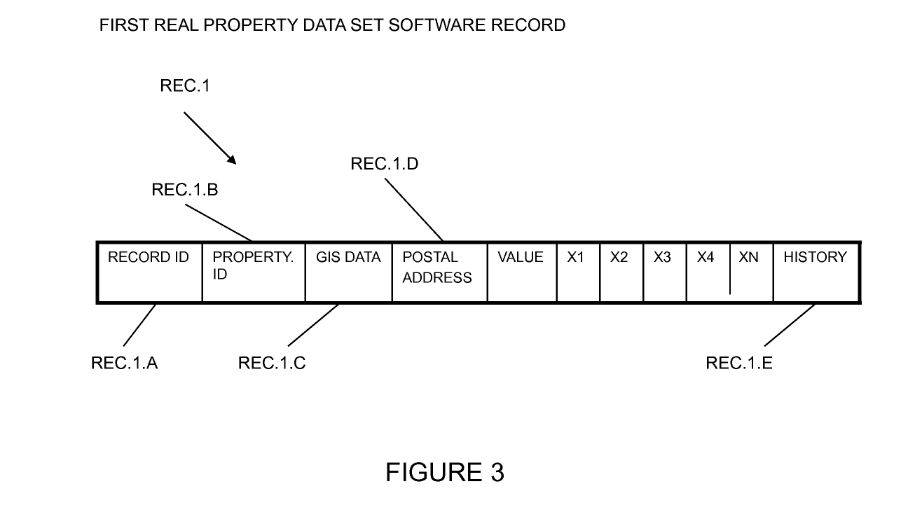

Referring now generally to the Figures and particularly to FIG. 2, FIG. 2 is an illustration of a representative first data set DS.1. The first data set DS.1 contains information descriptive of a first real property RE.1 located within the area A defined by the polygon. The first data set DS.1 is a plurality of parameters x₁ through xₙ and a financial value, the financial value being either a sales price or an appraised value. The complete first data set DS.1 is a descriptive document that registers quantitative values of defined qualities of, related to, and/or descriptive of the identified real property RE.1 As illustrated in FIG. 3, a plurality of these data sets DS.1-DS.N may be recorded individually in separate data set software records REC.1-REC.N and stored in an electronic, magnetic, and/or optical memory device.

Referring now generally to the Figures and particularly to FIG. 3, FIG. 3 is an illustration of a representative first real property data set record REC.1. The first real property record REC.1 includes a unique record identifier REC.1.A, a property identifier REC.1.B, a set of geographic information system (or “GIS”) or geospatial coordinates REC.1.C, a Postal Address data REC.1.D, the first data set of parameters x₁ through xₙ, of the first data set financial value, and a history data REC.1.E.

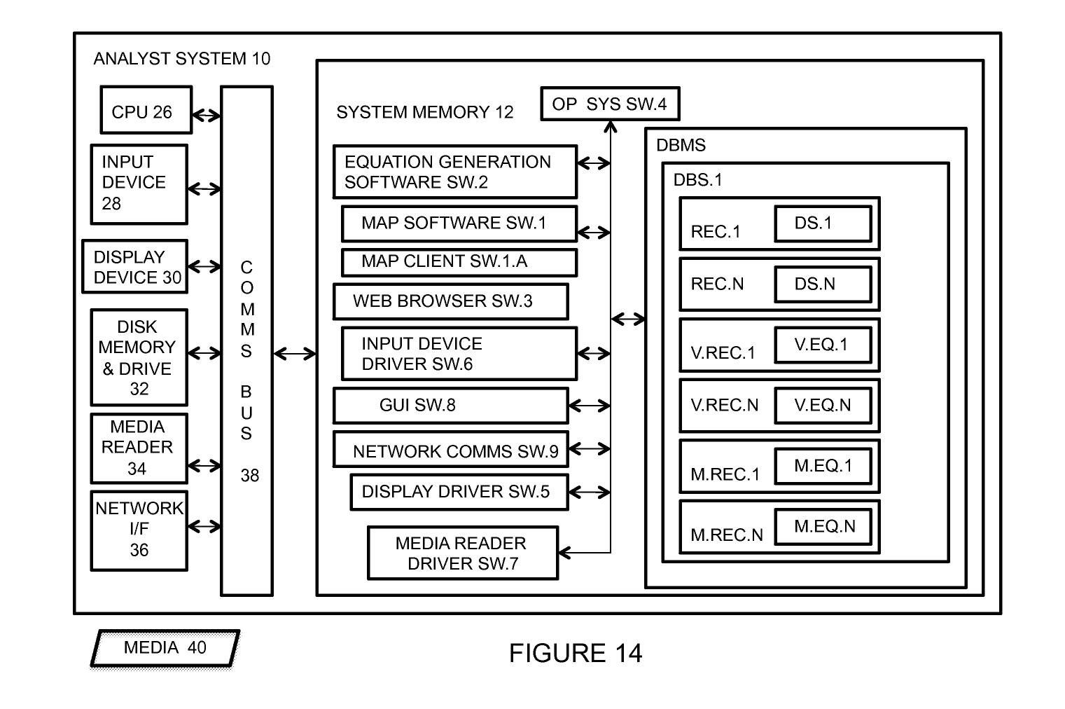

The unique record identifier REC.1.A uniquely identifies the real property data set record REC.1 within a database DBS.1, as further illustrated in FIG. 14. The property identifier REC.1.B uniquely identifies the first real property RE.1 to which the first data set DS.1, i.e., the financial value and the parameters x₁ through xₙ, describes or is related. The property identifier REC.1.B may be issued, generated, referenced and/or maintained by a governmental taxation agency, or other governmental agency having a charter that includes real property regulation or tracking. In the United States the property identifier REC.1.B may be or comprise an Assessors Parcel Number, or “APN”.

The real property data set record REC.1 further includes the set of geographic information system (or “GIS”) coordinates REC.1.C, or “GIS data” REC.1.C, of the first real property RE.1 that define the geographical location on the Earth of the first real property RE.1. The GIS data REC.1.C are assigned in accordance with a geographic coordinate system that enables every location on the Earth to be specified by a set of numbers. A common choice of coordinates is numbers specifying planetary latitude, longitude and ellipsoid height.

Using the geospatial polygon 6 created by a human analyst by means of a map software SW.1 that enables the human analyst to define the boundaries of the discrete finite market element that is defined by the area A. The area A real properties RE.1-RE.N can be identified as being inside the area A or outside the area A based on the unique, associated identifying geospatial coordinates of each real property RE.1-RE.N. According to the method of the present invention, the data sets DS.1-DS.N of the individual real properties RE.1-RE.N may also include information in one or more parameters x₁ through xₙ that enable consideration of location influences within a comprising market area A to be accounted for in predicting a sales price of a real property RE.1-RE.N. The invented method may, for example, account for the affect on a financial value of a real property RE.1-RE.N when the real property RE.1-RE.N is identified by a parameter x₁ through xₙ as a corner lot, or located within a certain school district, or indicating that a property RE.1-RE.N of the market area A is next or proximal to an external feature, such as a lake, or industrial site, or an automotive freeway.

The postal address RE.1.E may identify a physical location as specified or recognized by the United States Postal Service or other authority, of the referenced property.

The history data REC.1.E may contain additional information (a.) about the property associated with the real property software record REC.1; (b.) related to a geography comprising the referenced real property RE.1; and/or concerning the origin and history of the real property software record REC.1.E itself. The history data REC.1.E may additionally or alternatively include one or more sales price records, listing service-pricing values, appraisal records, and/or title history of the referenced property RE.1.

A plurality of real property software records REC.1-REC.N are stored in the first database DBS.1 and/or an electronic, magnetic, and/or optical memory device.

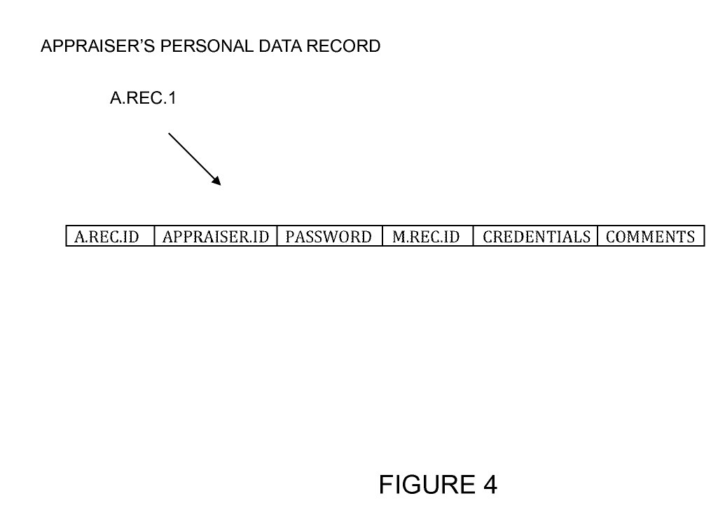

Referring now generally to the Figures and particularly to FIG. 4, FIG. 4 is illustration of a representative first individual appraiser's personal data record A.REC.1. The personal data record A.REC.1 relates to an individual human appraiser and includes a unique appraisal record identifier A.REC.ID, an identifier of a specific human appraiser APPRAISER.ID, and a user password PASSWORD. The appraiser identifier APPRAISER.ID and the password PASSWORD are used by an information technology system to confirm that a permission or access request from a user is actually being sent by, or is authorized by, the referenced appraiser.

A modified equation record data M.REC.ID may reference one or more unique identifiers of modified valuation equation records that contain valuation equations modified by the human analyst associated with the personal data record.

An optional credentials data CREDENTIALS identifies one or more educational degrees, awards, certifications and/or professional licenses held by the appraiser, and an optional comment data COMMENT includes additional information about the appraiser.

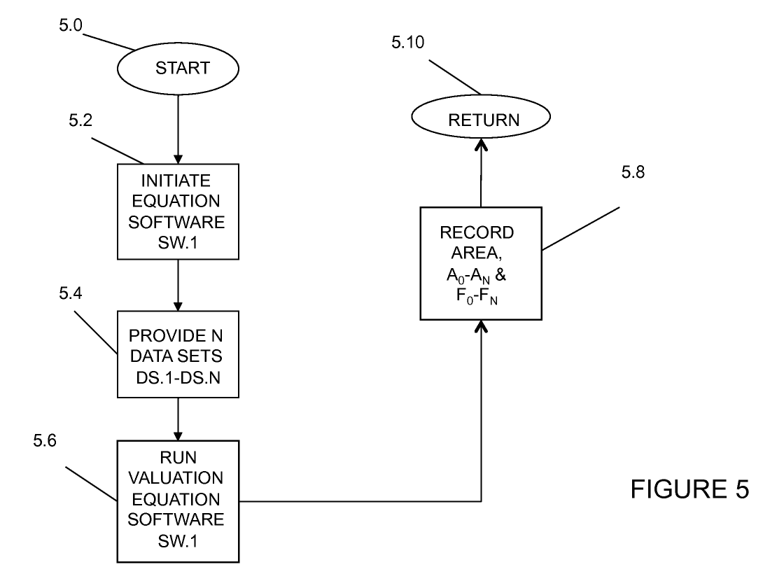

Referring now generally to the Figures and particularly to FIG. 5, FIG. 5 is a flow chart of a computer-implemented process wherein a market value and/or sales price equation V.EQ, e.g., a valuation equation V.EQ, is derived. In step 5.2 an automated valuation equation generation software program SW1. (“generation program”) is initiated. The valuation equation generation program SW.2 may apply one or more suitable valuation equation methods and/or algorithms to at least partly generate or derive the valuation equation, wherein such prior art techniques may include, but not necessarily be limited to, regression analysis; Bayesian linear regression; least absolute deviations; quantile regression; finite element analysis and modeling; nonparametric regression; distance metric learning; the Monte Carlo simulation method; neural network, and/or other suitable methods or algorithms known in the art.

In step 5.4 preferably a plurality of N or more data sets DS.1-DS.N are provided to the value equation generation program SW.2. The value equation generation program SW.2 processes the plurality of data sets in step 5.6 and outputs a valuation equation V.EQ. The valuation equation V.EQ is stored in an electronic system memory 12 of an analyst computer 10 in a valuation equation software record V.REC.1 in step 5.8. The valuation equation V/EQ specifies a plurality of coefficients a₀ through aₙ, and associated representations of mathematical operation information f₀ through fₙ, wherein each represented mathematical operation f₀ through fₙ has a one-to-one correspondence with a unique and individual coefficient a₀ through aₙ. Optionally, a geographic area to which the stored valuation equation should be applicable may be stored in the same valuation equation software record V.REC.1.-V.REC.N as the coefficients a₀ through aₙ and the operation information f₀ through fₙ.

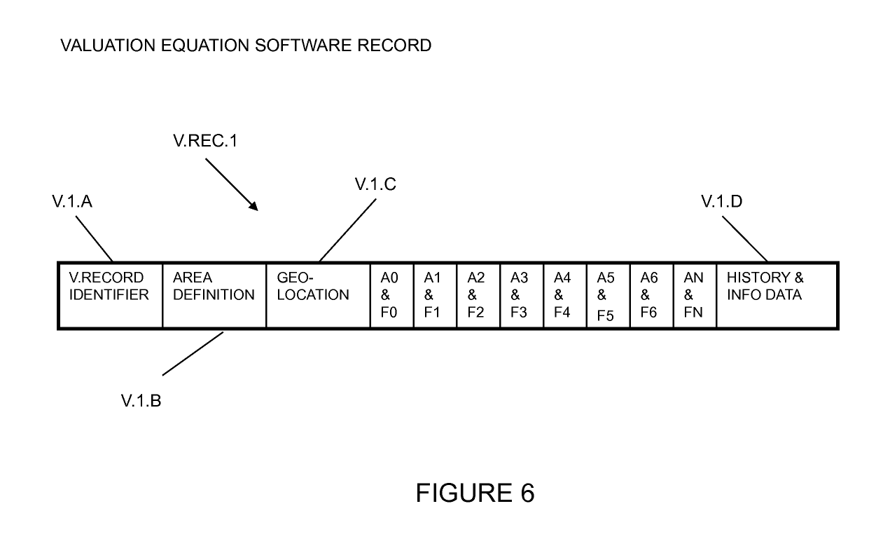

Referring now generally to the Figures and particularly to FIG. 6, FIG. 6 is an illustration of a representative first valuation equation software record V.REC.1. The first valuation equation software record V.REC.1 includes a unique valuation record identifier V.1.A and a mathematical area definition V.1.B that mathematically describes the area A to which the valuation equation V.EQ stored within the first valuation equation software record V.REC.1 may be applied. A geolocation identifier V.1.C may uniquely identify the area A. The coefficients a₀ through aₙ and each associated operation information f₁ through fₙ that comprise the valuation equation V.EQ are also stored in the first valuation equation software record V.REC.1. The first valuation equation record V.REC.1 further includes a history and information data V.1.D that includes information about the related geography and the history of the first valuation equation software record V.REC.1 itself.

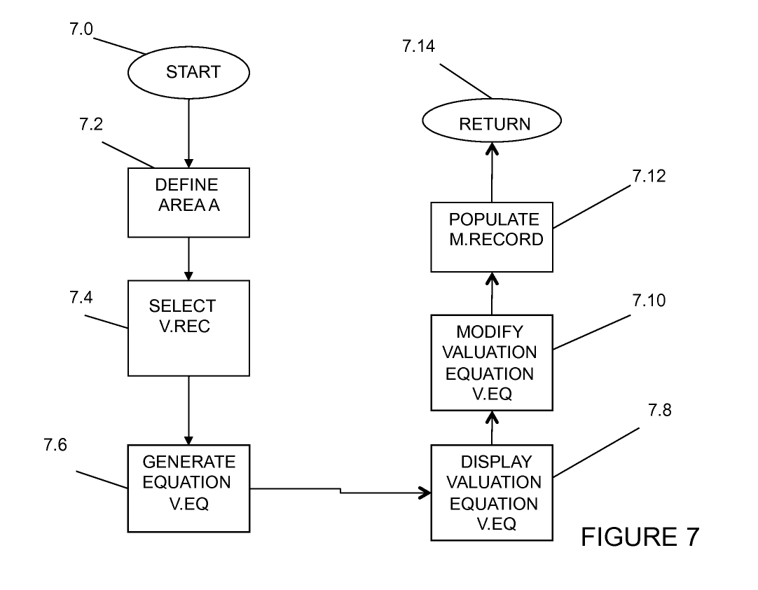

Referring now generally to the Figures and particularly to FIG. 7, FIG. 7 is process chart of a generation of a representative first modified value equation software record M.REC.1 by modification of a computationally generated valuation equation V.EQ by a human analyst. In step 7.2 the human analyst defines an area A within a geography by means of an analyst system 10. The area A by be defined to the analyst system 10 by means of the analyst interacting with a graphical user interface 8 or by providing GIS data or other geolocational data to the analyst system 2. In step 7.4 the analyst system 10 reviews all available real property data set records REC.1-REC.N and selects those records REC.1-REC.N that include a GIS data or a postal address that is located within the defined area A. The analyst system 10 next runs one or more valuation equation generation software programs SW.2 in step 7.6 and thereby generates a valuation equation V.EQ in step 7.6. The automatically generated valuation equation V.EQ is presented to the human analyst in step 7.8, and the analyst forms a modified valuation equation M.EQ in step 7.10 by (1.) modifying one or more coefficient and operation information pairs a₀ through aₙ and f₀ through fₙ of the valuation equation; (2.) deleting one or more coefficients a₀ through aₙ or paired operation information f₀ through fₙ of the valuation equation; and/or (3.) adding one or more additional coefficients a_{n+c} and paired operation information f_{n+c}. The modified valuation equation M.EQ is stored in a unique modified valuation equation software record V.REC.1 in step 7.12. The analyst system proceeds from step 7.12 to step 7.14 and to perform additional and alternate computational operations.

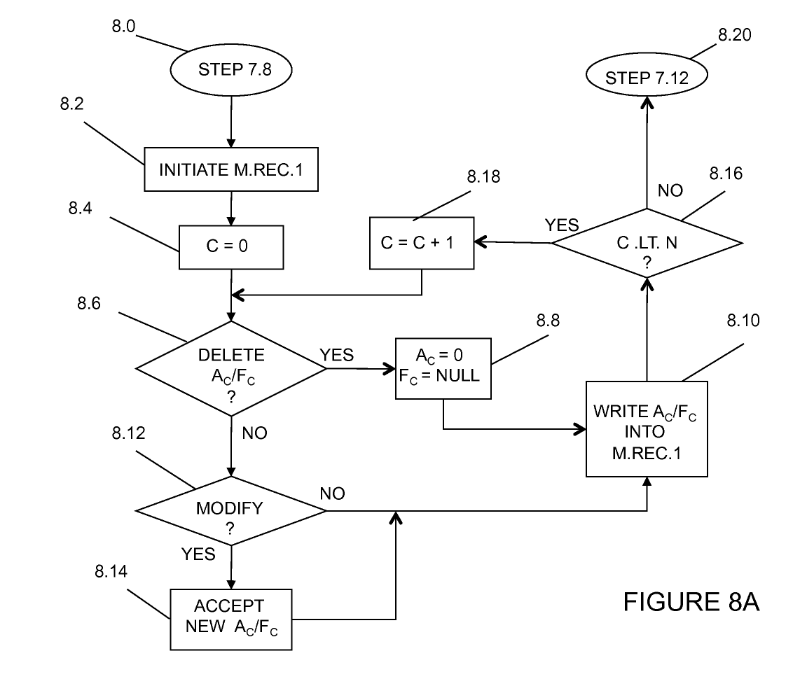

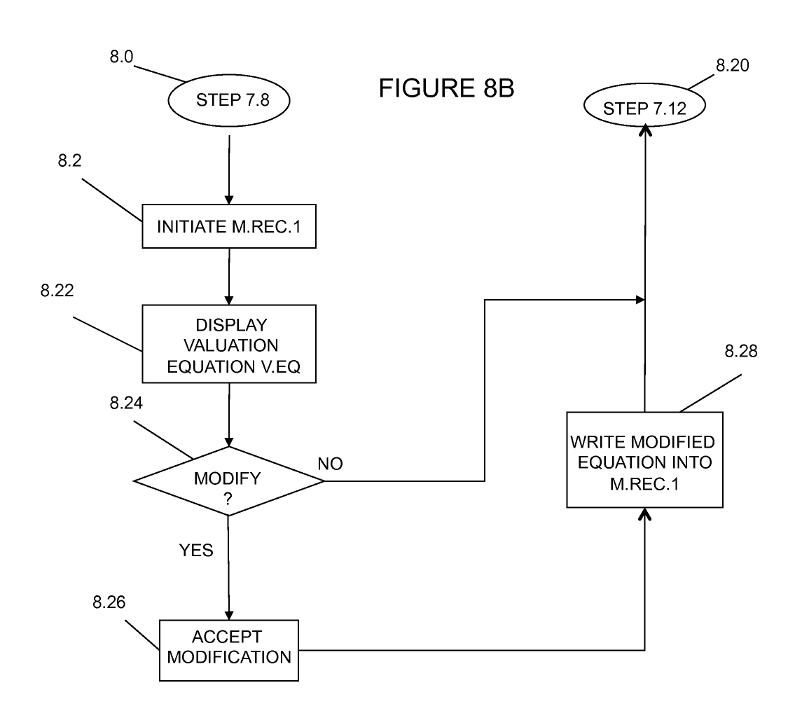

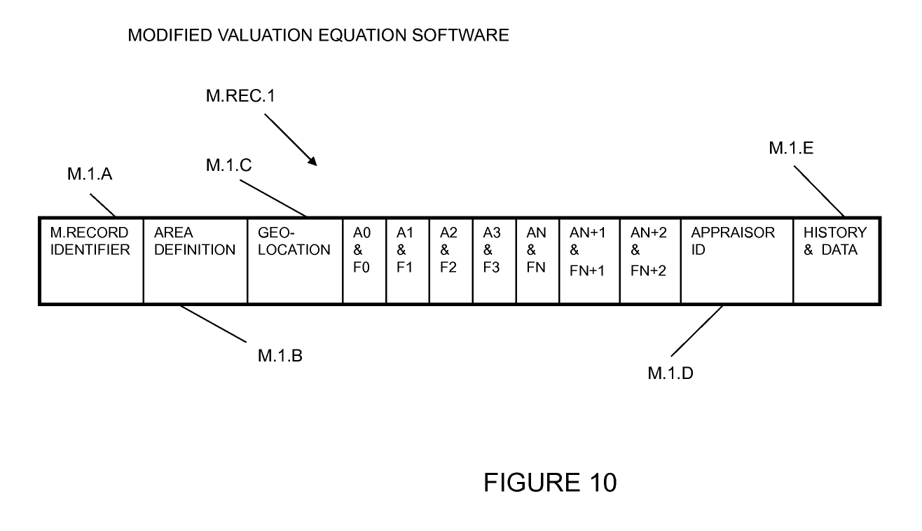

Referring now generally to the Figures and particularly to FIG. 8A and FIG. 10, FIG. 8A is a flow chart of certain alternate aspects of step 7.10 of the process of FIG. 7. In step 8.2 a representative first modified value equation record M.REC.1 is initiated and partly populated with (a.) a modified value equation record identifier M.1.A; (b.) a mathematical definition M.1.B of the geographic area, e.g., area A, to which a representative relevant first modified value equation M.EQ.1 may be applicable; (c.) GIS data, postal address, property identifiers and/or other geolocation data that may be useful or relevant M.1.C; (d.) a modifier identifier M.1.D of the appraiser, i.e., the human analyst, forming the modified valuation equation; (e.) other relevant history or data M.1.E. A counter C is set to zero in step 8.4, and the analysts system cycles through steps 8.6 to 8.18 until all coefficients a₀ through aₙ and paired operation information f₀ through fₙ have been reviewed by the analyst and possibly deleted or modified by the analyst prior to being written into the modified value equation a₀ through aₙ equal to zero, and to set certain operation information f₀ through fₙ to a “no operation” state, or null value, in step 8.6 and step 8.8. The effective deletion of the coefficients a₀ through aₙ and operation information f₀ through fₙ selected by the analyst in step 8.6 occurs by writing the zero value and null operation values into the first modified value equation record M.REC.1 in step 8.10.

The analysts directs the computer to modify the values of selected coefficients a₀ through aₙ, and to modify selected operation information f₀ through fₙ in step 8.12 and step 8.14. The original, or if modified, the modified coefficient .a₀ through aₙ and operation information f₀ through fₙ pairs, that in combination form the first modified valuation equation M.EQ.1 are written into the modified value equation record M.REC.1 in step 8.10.

In step 8.16 analyst system 10 determines whether each pair has been cycled through the partial loops of step 8.6 to step 8.14. When the counter C becomes equal to or greater than N, the analyst system determines that each and every coefficient a₀ through aₙ, and paired operation information f₀ through fₙ has been reviewed by the human analyst, and optionally modified or deleted. When the analyst system determines in step 8.16 that the counter C is less than the count N of coefficient a₀ through aₙ and operation information f₀ through fₙ pairs, the analyst system proceeds on to step 8.18 and increments the counter C by a one value. The analyst system then proceeds on to repeat an execution of step 8.6 through 8.16 with a succeeding coefficient a₀ through aₙ and operation information f₀ through fₙ of the original and computationally generated valuation equation.

Referring now generally to the Figures and particularly to FIG. 8B and FIG. 10, FIG. 8B is a flow chart of certain alternate aspects of step 7.10 of the process of FIG. 7. In step 8.2 the representative first modified value equation record M.REC.1 is initiated and partly populated with (a.) the modified value equation record identifier M.1.A; (b.) the mathematical definition M.1.B of the geographic area, e.g., area A, to which the relevant first modified value equation M.EQ.1 may be applicable; (c.) GIS data, postal address, property identifiers and/or other geolocation data that may be useful or relevant M.1.C; (d.) the modified record identifier M.1.D of the appraiser, i.e., the human analyst, forming the modified valuation equation; (e.) other relevant history or data M.1.E. In step 8.22 the valuation equation V.EQ of step 7.8 is displayed to the analyst via the display device 2 of the analyst system 10. The analyst system 10 determines in step 8.24 whether the analyst has issued a command via an input device 12 of the analyst system 10 to modify the displayed valuation equation V.EQ of step 8.22. The analyst system 10 accepts and applies the equation modification instructions as provided by the human analyst in step 8.26, and in step 8.28 the analyst system records the analyst-modified valuation equation M.EQ.1 into the first modified value equation record M.REC.1 of step 8.2. The analyst system 10 proceeds from either step 8.22 or step 8.28 to step 8.20 and therefrom to step 7.12.

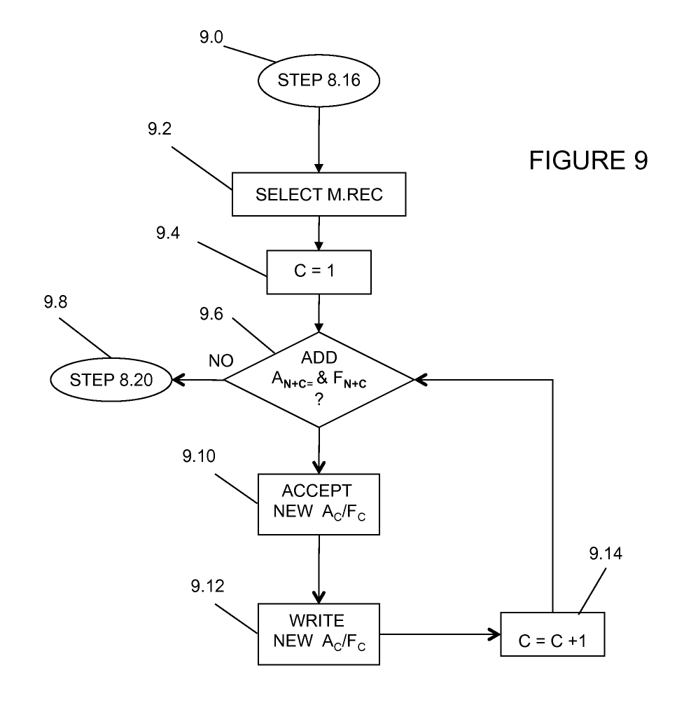

Referring now to FIG. 9, FIG. 9 is a flow chart of still alternate aspects of step 7.10 of the process of FIG. 7, where coefficients and relevant operation information are added to an analyst modified valuation equation M.EQ.1-M.EQ.N. In step 9.2 the first modified valuation equation record M.REC.1 is selected and opened, if not previously placed in a state for modification. The counter C is set to a one value in step 9.4, and the human analysts informs the analyst system 10 in step 9.6 whether a new coefficient a_{n+C} and paired operation information f_{n+C} shall be added to the first modified valuation equation record M.REC.1. The analyst computer 8 proceeds on from step 9.6 to step 9.8 and to proceed on to step 8.20 either (a.) when directed by the human analyst; or (b.) fails to receive an instruction to proceed from step 9.6 on to step 9.10 within some set time period, for example, after a one minute wait time period. The analyst system 10 receives a new coefficient a_{n+C} and paired operation information f_{n+C} in step 9.10, and writes the new coefficient a_{n+C} and paired operation information f_{n+C} into the _{first} modified valuation equation record M.REC.1 in step 9.12. The counter C is then incremented in step 9.14, and the analyst system 10 continues from step 9.14 onto another execution of step 9.6.

Referring now generally to the Figures and particularly to FIG. 10, FIG. 10 is an illustration of a representative first analyst-modified valuation equation software record M.REC.1. The first modified valuation equation software record M.REC.1 includes a modified value equation record identifier; (b.) a definition of the geographic area, e.g., area A, to which the relevant modified value equation may be applicable; (c.) GIS data, postal address, property identifiers and/or other geolocation data that may be useful or relevant; (d.) a plurality of coefficient a₀ through aₙ₊₃ and paired operation information f₀ through fₙ₊₃; (e.) an identifier of the appraiser, i.e., the human analyst, forming the modified valuation equation; and (f.) other relevant history or data.

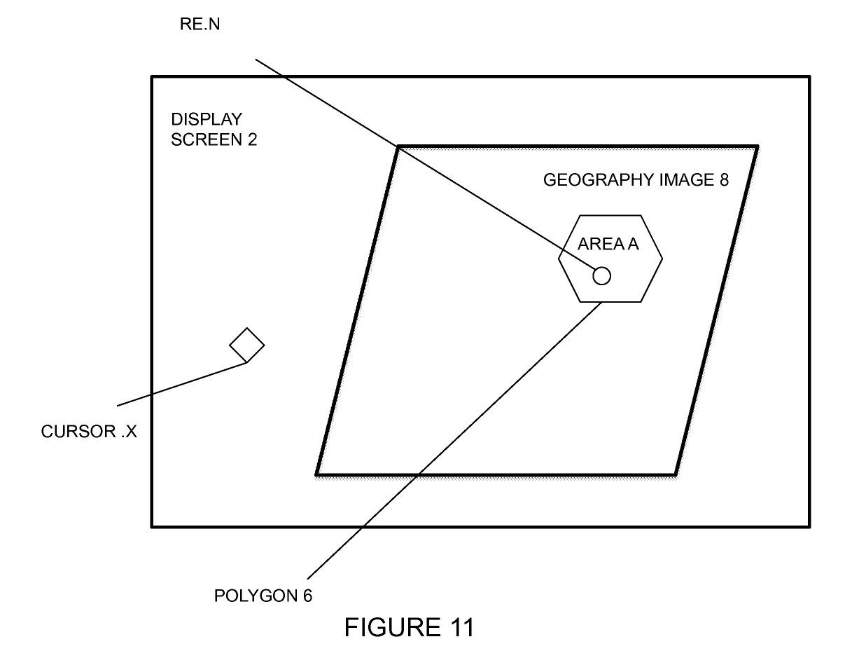

Referring now generally to the Figures and particularly to FIG. 11, FIG. 11 is an illustration of the computer display screen 2 presenting a graphical user interface 14 whereby a user may select a new property RE.N and may selectively direct THE hosting analyst system 10 to apply one or more market value and/or sale price equations. The rendered geography map 8 is displayed that represents the actual geography from which data related to real property RE.1-RE.N located within the area A was harvested and from which related data the first valuation equation V.EQ.1 was automatically generated.

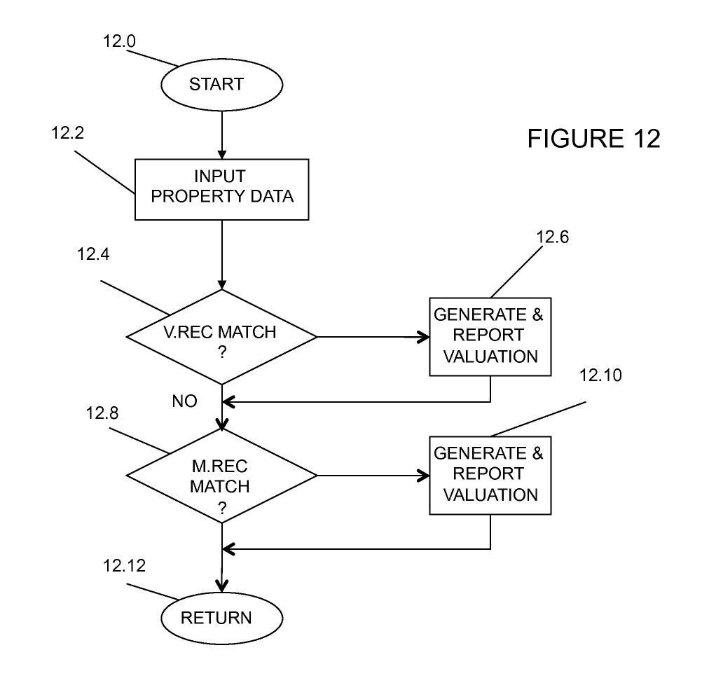

Referring now generally to the Figures and particularly to FIG. 12, FIG. 12 is a flowchart of a process wherein another person accesses an automatically generated valuation equation V.EQ.1-V.EQ.N and/or an analyst modified valuation equation M.EQ.1-M, EQ.N. A second person, or user, logs into a client system 16 in step 12.2 and inputs GIS data and/or other geolocational information into the client system 16. As directed by the user, the client system 16 forms and sends a search command in step 12.4 to an internal data base DBS.1 and/or other databases accessible to the client system 16 via the Internet 18, a wireless telephony system, a landline telephony system, and/or other electronic communications networks 20. The search command of step 12.4 directs one or more database management systems 22 to search for, and exercise, any computationally generated valuation equations that are applicable to the location of the property associated with the input data of step 12.2. When a valuation equation match is found in step 12.4, the client computer 16 generates or receives a predicted sales price and reports the predicted sales price to the user in step 12.6.

The client system 16 forms and sends a search command in step 12.8 to an internal data base DBS.1 and/or other databases accessible to the client system 16 via the Internet 18, a wireless telephony system, a landline telephony system, and/or other electronic communications networks 20. The search command of step 12.8 directs one or more database management systems 22 to search for, and exercise, any modified valuation equations M.EQ.1-M.EQ.N that are applicable to the location of the property associated with the input data of step 12.2. When a modified valuation equation match is found in step 12.4, the client computer generates or receives a predicted sales price and reports the predicted sales price to the user in step 12.10. The client system proceeds from step 12.8 or 12.10 to step 12.12 to perform additional and alternate computational operations.

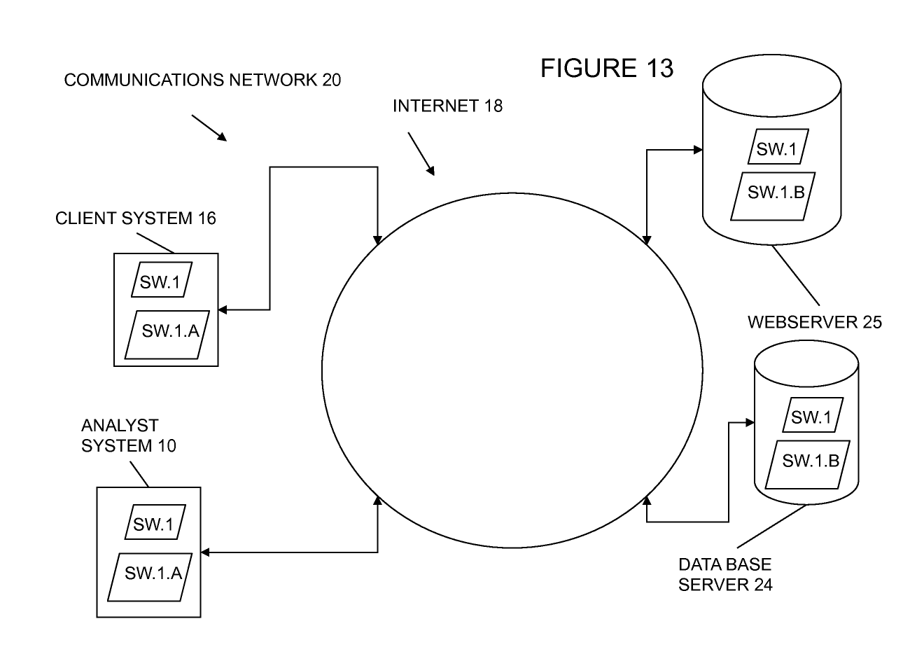

Referring now generally to the Figures and particularly to FIG. 13, FIG. 13 is a schematic of an electronics communications network 20 comprising the Internet 18, the client system 16, the analyst system 10, and a database server 24. A user seeking to receive a real property market price valuation, or forecast, directs the client system 16 to communicate with the database server 24 to secure one or more valuations. The human analyst uses the analyst system 10 to access and modify valuation equation software records V.REC.1-V.REC.N as stored in the database server 24, or elsewhere within the electronics communications network 2.

The mapping software SW.1, the valuation equation generation software SW.2, and/other software programs applied in accordance with the method of the present invention may be distributed between or among two or more elements 10, 16, 24 of the electronics communications network 20. For example, mapping software SW.1 may comprise a web service or Internet accessible service that is made available by human analyst and/or user executing the web browser SW.9, such as the FIREFOX™ as distributed by the Mozilla Corporation, to interact with a web service or a website accessible service, such as GOOGLE MAPS™ website graphical mapping service available at maps.google.com as hosted by Google, Inc. of Mountain View, Calif., the YAHOO! MAPS™ website graphical mapping service available athttp://maps.yahoo.com/ as hosted by Yahoo!, Inc., of Sunnyvale, Calif., and certain graphical mapping utility aspects of VIRTUAL ASSISTED VALUATION™ automated real property valuation service that is accessible via or at the website www.livevaluation.com. It is understood that in certain preferred embodiments of the method of the present invention that the mapping software SW.1 may comprise a client software SW.1.A that is executed and/or stored on the analyst system 10 and/or the client system 16 and another software module SW.1.B that is stored and/or executed at one or more database servers 24 and/or one or more webservers 25.

Referring now generally to the Figures and particularly to FIG. 14, FIG. 14 is a schematic of analyst system 10. It is understood that the client system 16, the database system 24, and/or the webserver 25 may comprise one or all of the elements represented FIG. 9. The client system 16, the analyst system 10, and the database server 24 may be or comprise (a.) a network-communications enabled SUN SPARCSERVER™ computer workstation marketed by Sun Microsystems of Santa Clara, Calif. running LINUX™ or UNIX™ operating system; (b.) a network-communications enabled personal computer configured for running WINDOWS XP™, VISTA™ or WINDOWS 7™ operating system marketed by Microsoft Corporation of Redmond, Wash.; (c.) a VAIO FS8900™ notebook computer marketed by Sony Corporation of America, of New York City, N.Y.; or (d.) a PowerBook G4™ personal computer as marketed by Apple Computer of Cupertino, Calif.

The client system 16 and/or the analyst system 10 may alternately be or comprise a portable digital communications device, such as (1.) a Nokia Model E61™ cellular telephone marketed by Nokia Corporation of Espoo Finland; (2.) a BLACKBERRY™ wireless personal digital assistant marketed by Research-in-Motion of Waterloo, Ontario, Canada; (3.) a VAIO FS8900™ notebook computer marketed by Sony Corporation of America, of New York City, N.Y.; (4.) POWERBOOK G4™ personal computer marketed by Apple Computer, Inc., of Cupertino, Calif.; or (5.) an iPhone™ cellular telephone marketed by Apple Computer, Inc., of Cupertino, Calif.

The analyst system 10 includes a central processing unit 26, the system memory 12, a data input peripheral 28, a display device 30 comprising the video display screen 2, a disk memory 32, a digital media reader 34, and a network interface 36 that are bi-directionally communicatively coupled by an internal communications bus 38.

The network interface 36 bi-directionally communicatively couples the analyst system 10 with the electronic communications network 20. The network interface 36 may alternatively or additionally be configured to send and receive wireless communications traffic and bi-directionally communicatively couple the analyst system 10 with the wireless telephony network.

The electronic media reader 34 is configured to read machine-executable instructions from a computer-readable medium 40, wherein the machine-executable instructions direct the analyst system 10 to perform one or more aspects or the steps of the method of the present invention.

The terms “computer-readable medium” and “computer-readable media” as used herein refer to any suitable tangible medium known in the art that participates in providing instructions to the analyst system 10. Such a medium may take many forms, including but not limited to, non-volatile tangible media and volatile tangible media, and transmission media. Non-volatile tangible media includes, for example, optical or magnetic disks, such as may be comprised within the system memory or the removable medium. Volatile media includes dynamic memory.

Common forms of computer-readable media include, for example, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge. The system memory 12 optionally includes a plurality of software modules, including the first database DBS.1, the database management system DBMS, the web browser SW.3, a software operating system SW.4, a display driver SW.5, an input device driver SW.6, and a media reader driver SW.7, a GUI software SW.8, and a network interface driver SW.9. The database management system DBMS may be or comprise and an object oriented database management system (“OODBMS”) and/or a relational database management system (“RDBMS”), and the first database DBS.1 may be or comprise an object oriented database and/or a relational database.

The display driver SW.5 enables the CPU 26 to cause the display device 30 to render the geographic map image 4, the geography image 8, the polygon 6, and the cursor. The input device driver SW.6 enables the CPU to accept and interpret signals received from the input device 28 and/or optionally the display screen 2 when the display screen 2 is a touch screen device. The media reader driver SW.7 enables communication between the CPU 26 and the media reader 34. The GUI software SW.8 enables the CPU to display graphical user interface on the video display screen 2, to include the geographic map image 4, the geography image 8, the polygon 6, and the cursor. The network interface driver SW.9 enables the network interface 36 to bi-directionally communicatively couple the analyst system 10 with the electronic communications network 20.

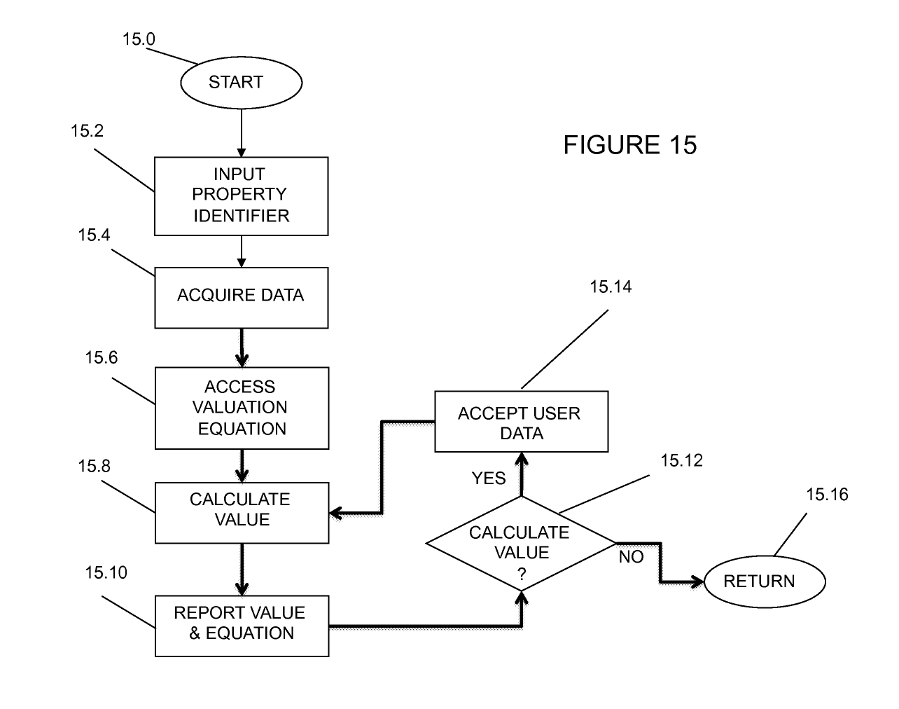

Referring now generally to the Figures and particularly to FIG. 15, FIG. 15 is a flowchart of a method implemented by the client system 16 of FIGS. 13 and 14 in interaction with the user to generate varied valuations of one or more real properties RE.1-RE.N of FIG. 1. The user provides an identifier REC.1.B of a first real property RE.1 to the client system 16 and the client system 16 accepts the identifier REC.1.B of the first real property RE.1 in step 15.2. The client computer 16 seeks and acquires data descriptive of the first real property RE.1 and/or the environs of the first real property RE.1 in step 15.4 from the system memory 12 of the client system 16, the communications network 2, the analyst system 10, and/or one or more networked media storage servers 24. The client computer 16 accesses, or generates, a predictive price valuation equation V.EQ that is generated from real property data related to the Area A in which the first real property RE.1 is located. The client system 16 then calculates a predictive price of the first real property RE.1 in step 15.8 by applying the data acquired in step 15.4 to the value equation V.EQ accessed and/or generated in step 15.8. The predictive price of the first real property RE.1, and optionally the valuation equation V.EQ of step 15.6, is provided to the user by means of the display device 2 of the client system 16 in step 15.10.

The client system 16 determines in step 15.12 whether the user has directed the client system 16 to calculate an alternative predictive price by accepting new data in step 15.14 and applying the new data in an additional execution of step 15.8 with an additional calculation of the valuation equation V.EQ of step 15.6. Multiple executions of the loop of step 15.8 through 15.14 enables the user to receive various predictive prices of the first real property RE.1 based upon notional changes of states and/or conditions related to or of the first property and/or related to or of the environs of the first real property RE.1. For example, the user might provide data in step 15.14 that notionally specifies the first real property RE.1 has having an additional bathroom or an additional bedroom.

Another application of the method of FIG. 15 is to enable a user to calculate a possible reduction in market value of the first real property RE.1 on the basis of a decline in a state or condition of the first real property RE.1. For example, a foreclosure of the property, or a hostile tenancy, or physical damage to walls or windows may be reflected in data provided to the client system 16 in one or more executions of step 15.14. In an additional process, user may apply the loop of steps 15.8 through 15.14 at time separated instances. For example, a case of a foreclosure of the first real property RE.1 is illustrative. A full inspection appraisal is first performed on the first real property RE.1 after a foreclosure decision is reached. The results of this appraisal are uploaded into the client system 16 in an execution of step 15.14. The predictive price may then be calculated by an execution of step 15.8 on, or near, the date of foreclosure. The user may at a later date, for example, thirty days after the foreclosure date, perform an inspection of the first real property RE.1. New parameters describing the first real property RE.1 and/or the environs of the first real property RE.1 are then uploaded into the client system 16 in an additional execution of step 15.14. A new, or updated, predictive price is generated in another execution of step 15.8 the basis of the data most recently provided by the user in step 15.14, wherein the resultant predictive value calculated in step 15.8 may reflect, and be affected by, the new characteristics and economic influences that have occurred in the 30 days as following the foreclosure date. The calculation of step 15.8 may alternately or additionally by the client computer 16 applying a valuation equation M.EQ.1-M.EQ.N that has been updated or modified since the date of foreclosure.

Optionally, alternatively and/or additionally, the client system 16 may require a financial payment from the user or a third party, or a promise of a financial payment by the user or a third party, to complete the provision of the predictive price in step 15.10.

Optionally, alternatively and/or additionally, the user may provide a plurality of data sets to the client computer 16, wherein each data set is separately related to specific and unique real properties. The user may thereby apply the method of the present invention to manage portfolios of properties and/or mortgage instruments.

Optionally, alternatively and/or additionally, the user may vary the valuation equation of step 15.6 to reflect a forecasted valuation of a sales price of the first real property RE.1 on a basis of possible or expected changes in the real property market and/or market values.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. The examples given should only be interpreted as illustrations of some of the applications of the present invention, and the full scope of the present invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

What is claimed is:

1. A method of applying human expertise to adapt a valuation equation, the method comprising:
a. Directing a computer to generate a valuation equation from an automated analysis of a plurality of values, wherein each value is related to one of a second plurality of paired coefficients and parameters, wherein each pair of a coefficient and a parameter is multiplied together and the resultants are summed to equal the associated value;
b. Providing the plurality of coefficients to a human analyst;
c. Forming an adapted plurality of coefficients by accepting from the human analyst an adaptation of at least one coefficient; and
d. Deriving a value from a set of parameters by applying the valuation equation with the adapted plurality of coefficients.

2. The method of claim 1, wherein the valuation is a predicted sales price of a real property.

3. The method of claim 2, wherein the adaptation of the at least one coefficient includes setting the coefficient to a zero value.

4. The method of claim 2, wherein the adaptation of the at least one coefficient includes adding a new coefficient for operation with an additional parameter.

5. The method of claim 4, wherein the adaptation of the at least one coefficient includes a binary mathematical operation applied with the at least one coefficient and the additional parameter and the binary mathematical operation is selected from the mathematical operation group consisting of division, subtraction, integration, squaring, cubing, and derivation of a root value of the parameter.

6. The method of claim 1, wherein the set of parameters are all associable with a class of real property.

7. The method of claim 1, wherein the human analyst directs the computer to select the plurality of assigned values from an area of contiguous real property.

8. The method of claim 4, wherein the human analyst defines the area of contiguous real property means of a graphical user interface applied to a representation of geography.

9. The method of claim 4, wherein at least one assigned value is associated with a real property comprising a dwelling.

10. The method of claim 1, wherein the adapted plurality of coefficients are applied to a second set of parameters to generate a second value determination.

11. The method of claim 1, wherein the value includes a quantitative contribution of a binary mathematical operation applied with at least one coefficient and parameter pair and the binary mathematical operation is selected from the mathematical operation group consisting of division, subtraction, integration, squaring, cubing, and derivation of a root value of the parameter.

12. A method comprising:
a. Defining a sales price predictive valuation equation derived from a plurality of real estate valuations, the sales price valuation equation specifying at least two coefficients that are each related to a separate quality of real property;
b. Associating the valuation equation with a geographic area;
c. Providing the sales price valuation equation to a human analyst;
d. Enabling the human analyst to modify the valuation equation;
e. Applying a modification of the sales price valuation equation by the human analyst; and
f. Providing the modified sales price valuation equation to another party.

13. The method of claim 12, wherein the valuation equation is at least partially derived by regression analysis.

14. The method of claim 12, wherein the valuation equation is at least partially derived by a valuation equation generation method selected from the group consisting of regression analysis; Bayesian linear regression; least absolute deviations; quantile regression; finite element analysis and modeling; nonparametric regression; distance metric learning; and the Monte Carlo simulation method

15. The method of claim 12, wherein the valuation equation is modified by the human analyst changing a coefficient value of the valuation equation.

16. The method of claim 12, wherein the valuation equation is modified by the human analyst changing a mathematical operation of a coefficient of the valuation equation with a parameter of the valuation equation.

17. The method of claim 12, wherein the human analyst is provided with a data set prior to the modification of the valuation equation, the data set related to a real property located within the geography, the data set comprising a plurality of data applicable with the sales price valuation equation to generate a predicted sales price of the real property.

18. The method of claim 12, wherein the valuation equation is provided to the human analyst by means of an electronic communications network.

19. The method of claim 12, wherein the valuation equation is provided to the human analyst via the Internet.

20. A system for predicting real estate valuations, comprising:
a. A predictive model associated with a geography and for generating a real estate valuation; and
b. Means to enable the human analyst to modify the predictive model computation as applied to predictive sales price valuations of real property located within the geography.

21. The system of claim 20, wherein the predictive model is computationally derived by a valuation equation generation method selected from the group consisting of regression analysis; Bayesian linear regression; least absolute deviations; quantile regression; finite element analysis and modeling; nonparametric regression; distance metric learning; and the Monte Carlo simulation method.

22. The system of claim 20, wherein the system is accessible via an electronics communications network for use in generating predicted sales prices of real property located within the geography.

23. The system of claim 20, wherein the electronics communications network comprises the Internet.
